(19) United States
(12) Patent Application Publication
(10) Pub. No.: US 2014/0169452 A1
(43) Pub. Date: Jun. 19, 2014

(54) VIDEO ENCODING METHOD AND APPARATUS USING THE SAME

(71) Applicants: Sung Chang LIM, Daejeon-si (KR); Jong Ho KIM, Daejeon-si (KR); Hui Yong KIM, Daejeon-si (KR); Jin Soo CHOI, Daejeon-si (KR); Jin Woong KIM, Daejeon-si (KR)

(72) Inventors: Sung Chang LIM, Daejeon-si (KR); Jong Ho KIM, Daejeon-si (KR); Hui Yong KIM, Daejeon-si (KR); Jin Soo CHOI, Daejeon-si (KR); Jin Woong KIM, Daejeon-si (KR)

(73) Assignee: ELECTRONICS AND TELECOMMUNICATIONS RESEARCH INSTITUTE, Daejeon-si (KR)

(21) Appl. No.: 14/104,240

(22) Filed: Dec. 12, 2013

(30) Foreign Application Priority Data
Dec. 14, 2012 (KR) 10-2012-0146661
Dec. 12, 2013 (KR) 10-2013-0154787

(51) Int. Cl. H04N 19/12; H04N 19/147; H04N 19/176

(52) U.S. Cl. CPC H04N 19/00078; H04N 19/00278; H04N 19/00175
USPC 375/240.03

(57) ABSTRACT

Disclosed is a video encoding method, including: generating a residual block corresponding to a difference between a target block of an original video and a prediction block for the target block; calculating a first rate-distortion cost by transforming, quantizing, and encoding the residual block; judging whether an encoded block flag indicating whether a residual signal of the residual block is present is 0; and deciding a transform mode as not applying a transform skip mode to the residual block when the encoded block flag is 0 according to a result of the judgment.

This application claims the benefit of priority of Korean Patent Application Nos. 10-2012-0146661 filed on Dec. 14, 2012 and 10-2013-0154787 filed on Dec. 12, 2013, which is incorporated by reference in its entirety herein.

### BACKGROUND OF THE INVENTION

1. Field of the Invention

The present invention relates to video encoding processing, and more particularly, to a method and an apparatus for encoding a video that determine a transform mode at a high speed.

2. Discussion of the Related Art

In recent years, as a broadcasting service having high definition resolution (1280×1024 or 1920 or 1080) has been extended globally as well as domestically, a lot of users have been familiar with a high-resolution, high-definition video now and a lot of institutions have spurred development of a next-generation video apparatus by keeping up therewith. Further, moving picture standardization groups have perceived the necessity of compression technology of a higher-resolution, higher-definition video with an increase of a concern about ultra high definition (UHD) having four times higher resolution than an HDTV as well as the HDTV. In addition, a new standard is urgently needed, which can acquire a lot of gains in terms of a frequency band or storage while maintaining the same definition through higher compression efficiency than H.264/AVC used in the HDTV, a cellular phone, and a blu-ray player at present. At present, Moving Picture Experts Group (MPEG) and Video Coding Experts Group (VCEG) commonly aims at standardizing High Efficiency Video Coding (HEVC) which is a next-generation video codec and encoding a video including a UHD video with twice higher compression efficiency than the H.264/AVC. This can provide a high-definition video at a lower frequency than at present even in 3D broadcasting and a mobile communication network as well as the HD and UHD videos.

At present, the HEVC sets a codec called an HEVC test model (HM) through a contribution of each institution after a first Joint Collaboration Team Video Coding (JCT-VC) meeting was opened in April, 2010.

### SUMMARY OF THE INVENTION

An object of the present invention is to a method for determining a high-speed transform skip mode for luminance and chrominance components in a screen that determines whether rate-distortion cost calculation is performed for a transform skip mode with a block flag encoded to reduce complexity of an encoder.

Another object of the present invention is to provide a method that can determine a transform mode of the chrominance component in response to the encoded block flag of the luminance component.

In accordance with an embodiment of the present invention, a video encoding method may include: generating a residual block corresponding to a difference between a target block of an original video and a prediction block for the target block; calculating a first rate-distortion cost by transforming, quantizing, and encoding the residual block; judging whether an encoded block flag indicating whether a residual signal of the residual block is present is 0; and deciding a transform mode as not applying a transform skip mode to the residual block when the encoded block flag is 0 according to a result of the judgment.

The method may further include calculating a second rate-distortion cost by quantizing and encoding the residual block without transformation when the encoded block flag is not 0 according to the judgment result.

The method may further include: comparing the first rate-distortion cost and the second rate-distortion cost with each other; deciding the transform mode as applying the transform skip mode to the residual block when the first rate-distortion cost is equal to or larger than the second rate-distortion cost according to a result of the comparison; and deciding the transform mode as not applying the transform skip mode to the residual block when the first rate-distortion cost is smaller than the second rate-distortion cost according to a result of the comparison.

An intra-screen prediction may be applied to the prediction block.

The residual block may be a luminance block including a luminance component.

The residual block may be a luminance block including a luminance component.

In accordance with another embodiment of the present invention, a video encoding method may include: generating a first residual block corresponding to a difference between the target block of the original video and a luminance block constituted by luminance components for the target block and a second residual block corresponding to a difference between the target block and a chrominance prediction block constituted by chrominance components for the target block; calculating the first rate-distortion cost by transforming, quantizing, and encoding the first residual block; judging whether an encoded block flag indicating whether a residual signal of the first residual block is present is 0; and deciding the transform mode as not applying a transform skip mode to the second residual block and transforming, quantizing, and encoding the second residual block when the encoded block flag is 0 according to a result of the judgment.

The method may further include: when the encoded block flag is not 0 according to the judgment result, calculating a second rate-distortion cost by transforming, quantizing, and encoding the second residual block; calculating a third rate-distortion cost without transforming, quantizing, and encoding the second residual block; comparing the second rate-distortion cost and the third rate-distortion cost with each other; deciding the transform mode as applying the transform skip mode to the second residual block when the second rate-distortion cost is equal to or larger than the third rate-distortion cost according to a result of the comparison; and deciding the transform mode as not applying the transform skip mode to the second residual block when the second rate-distortion cost is smaller than the third rate-distortion cost according to a result of the comparison.

The size of the second residual block may be 4×4, the first residual block having a size of 8×8 corresponding to the second residual block may be divided, and the sum of encoded block flags for the first residual blocks which are divided may be equal to or more than 1.

In accordance with yet another embodiment of the present invention, a video encoding apparatus may include: a subtractor generating a residual block corresponding to a difference between a target block of an original video and a prediction block for the target block; an encoding module calculating a first rate-distortion cost by transforming, quantizing, and encoding the residual block; and a control module judging whether an encoded block flag indicating whether a residual signal of the residual block is present is 0 and according to a result of the judgment, when the encoded block flag is 0, deciding the transform mode as not applying the transform skip mode to the residual block.

In accordance with still another embodiment of the present invention, a video encoding method may include: a subtractor generating a first residual block corresponding to a difference between the target block of the original video and a luminance block constituted by luminance components for the target block and a second residual block corresponding to a difference between the target block and a chrominance prediction block constituted by chrominance components for the target block; an encoding module calculating the first rate-distortion cost by transforming, quantizing, and encoding the first residual block; and a control module judging whether an encoded block flag indicating whether a residual signal of the first residual block is present is 0 and according to a result of the judgment, when the encoded block flag is 0, deciding the transform mode as not applying the transform skip mode to the second residual block, and controlling the encoding module to transform, quantize, and encode the second residual block.

According to an embodiment, complexity of an encoder is reduced.

There are provided a method for determining a high-speed transform skip mode for luminance and chrominance components in a screen that determines whether rate-distortion cost calculation is performed for a transform skip mode with an encoded block flag and an apparatus using the same.

There are provided a method that can determine a transform mode of the chrominance component in response to the encoded block flag of the luminance component and an apparatus using the same.

### BRIEF DESCRIPTION OF THE DRAWINGS

FIG. 1 is a block diagram illustrating a configuration of a video encoding apparatus according to an embodiment of the present invention.

FIG. 2 is a block diagram illustrating a configuration of a video decoding apparatus according to an embodiment of the present invention.

FIG. 3 is a partial conceptual diagram of an encoding apparatus adopting a transform skip mode according to the present invention.

FIG. 4 is a diagram illustrating an average and a distribution of residual blocks in the case where the transform skip mode is applied to a predetermined screen contents video (SlideEditing) and the in the case where the transform skip mode is not applied.

FIG. 5 is a diagram illustrating an average and a distribution of residual blocks in the case where the transform skip mode is applied to another screen contents video and in the case where the transform skip mode is not applied.

FIG. 6 is a control flowchart for describing a method for determining a luminance transform skip mode in a high-speed screen according to the present invention.

FIG. 7 is a control block diagram of an encoder according to an embodiment of the present invention.

FIG. 8 is a graph illustrating a probability that an encoded block flag of a luminance block is 1 in the case where an encoded block flag of a chrominance block is 1.

FIG. 9 is a control flowchart for describing a method for determining a luminance transform skip mode in a high-speed screen according to an embodiment of the present invention.

### DETAILED DESCRIPTION OF THE EMBODIMENTS

Hereinafter, embodiments of the present invention will be described in detail with reference to the accompanying drawings. In describing the embodiments of the present specification, when it is determined that the detailed description of the known art related to the present invention may obscure the gist of the present invention, the detailed description thereof will be omitted.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. Moreover, a content of describing “including” a specific component in the present invention does not exclude a component other than the corresponding component and means that an additional component may be included in the embodiments of the present invention or the scope of the technical spirit of the present invention.

Terminologies such as first or second may be used to describe various components but the components are not limited by the above terminologies. The above terminologies are used only to discriminate one component from the other component. For example, without departing from the scope of the present invention, a first component may be referred to as a second component, and similarly, a second component may be referred to as a first component.

Further, components described in the embodiments of the present invention are independently illustrated in order to show different characteristic functions and each component is not constituted by separated hardware or one software constituting unit. That is, each component is arranged and included as the respective components and at least two components among the respective components are added up to form one component or one component is divided into a plurality of components to perform functions and the integrated embodiment and separated embodiments of each component are also included in the scope of the present invention without departing from the spirit of the present invention.

Further, some components are not requisite components that perform essential functions but selective components for just improving performance in the present invention. The present invention may be implemented with the requisite component for implementing the spirit of the present invention other than the component used to just improve the performance and a structure including only the requisite component other than the selective component used to just improve the performance is also included in the scope of the present invention.

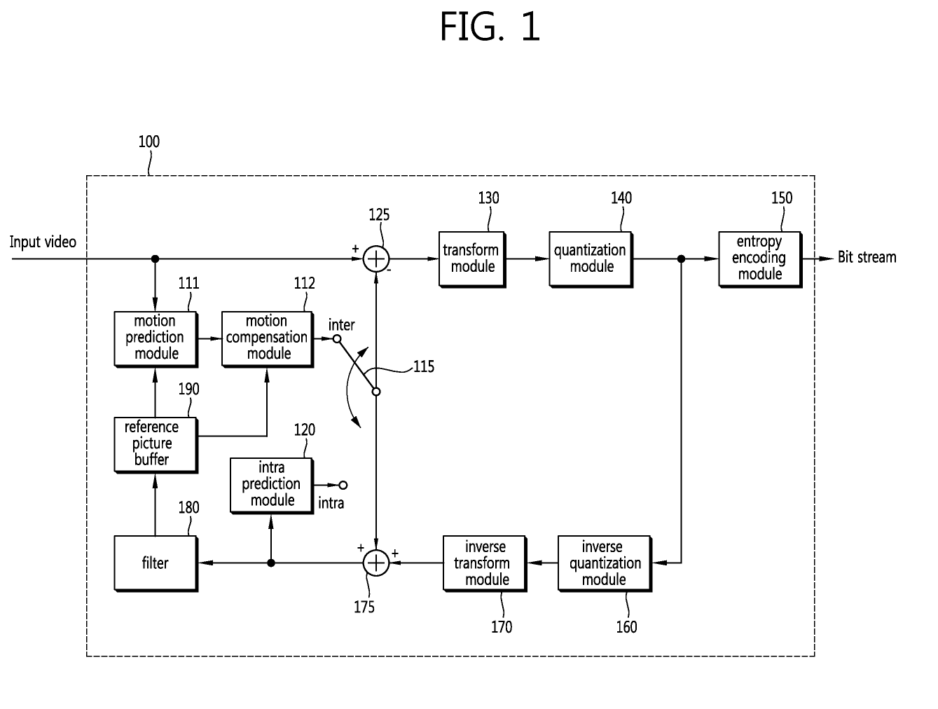

FIG. 1 is a block diagram illustrating a configuration of a video encoding apparatus according to an embodiment of the present invention.

Referring to FIG. 1, the video encoding apparatus 100 includes a motion prediction module 111, a motion correction module 112, an intra prediction module 120, a switch 115, a subtractor 125, a transform module 130, a quantization module 140, an entropy coding module 150, an inverse quantization module 160, an inverse transform moduleinverse transform module 170, an adder 175, a filter module 180, and a reference video buffer 190.

The video encoding apparatus 100 may encode an input video in an intra mode or an inter mode, and output a bit stream. The intra prediction means an intra-screen prediction and the inter prediction means an inter-screen prediction. In the intra mode, the switch 115 is shifted to ‘intra’, and in the inter mode, the switch 115 is shifted to ‘inter’. The video encoding apparatus 100 generates a prediction block for an input block of the input video, and then may encode a difference between the input block and the prediction block.

In the intra mode, the intra prediction module 120 performs a spatial prediction by using a pixel value of a pre-encoded block around a current block to generate the prediction block.

In the inter mode, the motion prediction module 111 may find a region which is most matched with the input block in a reference video stored in the reference video buffer 190 during the motion prediction process to calculate a motion vector. The motion correction module 112 corrects the motion by using the motion vector and the reference video stored in the reference video buffer 190 to generate the prediction block.

The subtractor 125 may generate a residual block by the difference between the input block and the generated prediction block. The transform module 130 performs transform for the residual block to output a transform coefficient. In addition, the quantization module 140 quantizes the input transform coefficient according to a quantization parameter to output a quantized coefficient.

The entropy encoding module 150 entropy-encodes symbols according to probability distribution based on values calculated from the quantization module 140 or coding parameter values calculated in the encoding process to output a bit stream. The entropy encoding method is a method in which symbols having various values are received and expressed by decodable binary strings while removing statistical redundancy.

Here, the symbol means an encoding/decoding target syntax element, a coding parameter, a value of a residual signal, and the like. The coding parameter, as a parameter required for encoding and decoding, may include not only information encoded in the encoding apparatus to be transferred to the decoding apparatus like the syntax element, but also information which may be inferred from the encoding or decoding process, and means information required when the video is encoded or decoded. The coding parameter may include values or statistics of for example, an intra/inter prediction mode, a movement/motion vector, a reference video index, an encoding block pattern, presence of a residual signal, a transform coefficient, a quantized transform coefficient, a quantization parameter, a block size, block segment information, and the like. Further, the residual signal may mean a difference between an original signal and a prediction signal, and may also mean a signal having a transformed form of the difference between the original signal and the prediction signal or a signal having a transformed and quantized form of the difference between an original signal and a prediction signal. The residual signal may be referred to as a residual block in a block unit.

In the case where the entropy encoding is applied, a few of bits are allocated to a symbol having high occurrence probability and a lot of bits are allocated to a symbol having low occurrence probability to express the symbols, and as a result, a size of a bit stream for encoding target symbols may be reduced. Accordingly, compression performance of video encoding may be enhanced through the entropy encoding.

For the entropy encoding, encoding methods such as exponential golomb, context-adaptive variable length coding (CAVLC), and context-adaptive binary arithmetic coding (CABAC) may be used. For example, a table for performing the entropy encoding such as a variable length coding/code (VLC) table may be stored in the entropy encoding module 150, and the entropy encoding module 150 may perform the entropy encoding by using the stored VLC table. Further, the entropy encoding module 150 derives a binarization method of a target symbol and a probability model of a target symbol/bin, and then may also perform the entropy encoding by using the derived binarization method or probability model.

The quantized coefficient may be inversely quantized in the inverse quantization module 160 and inversely transformed in the inverse transform moduleinverse transform module 170. The inversely quantized and inversely transformed coefficient is added to the prediction block by the adder 175 to generate a restore block.

The restore block passes though the filter module 180, and the filter module 180 may apply at least one of a deblocking filter, a sample adaptive offset (SAO), and an adaptive loop filter (ALF) to the restore block or a restore picture. The restore block passing through the filter module 180 may be stored in the reference video buffer 190.

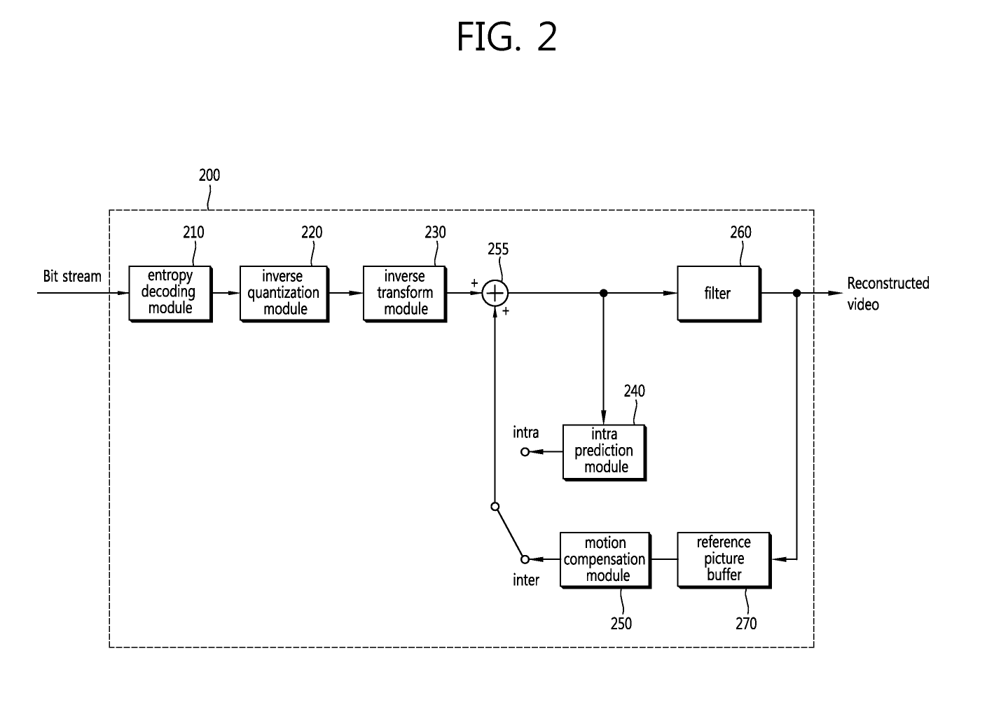

FIG. 2 is a block diagram illustrating a configuration of a video decoding apparatus according to an embodiment of the present invention. Referring to FIG. 2, the video decoding apparatus 200 includes an entropy encoding module 210, an inverse quantization module 220, an inverse transform module 230, an intra prediction module 240, a motion correction module 250, a filter module 260, and a reference video buffer 270.

The video decoding apparatus 200 receives a bit stream output from the encoding apparatus to perform decoding in an inter mode or an inter mode and output a reconfigured video, that is, a restore video. In the intra mode, the switch may be shifted to ‘intra’, and in the inter mode, the switch may be shifted to ‘inter’. The video decoding apparatus 200 obtains a residual block restored from the input bit stream and generates a prediction block, and then may generate the reconfigured block, that is, the restore block by adding the restored residual block and the prediction block.

The entropy decoding module 210 entropy-decodes the input bit stream according to probability distribution to generate symbols including a symbol having a quantized coefficient form. The entropy decoding method is a method of receiving binary strings to generate respective symbols. The entropy decoding method is similar to the aforementioned entropy encoding method.

The quantized coefficient is inversely quantized in the inverse quantization module 220 and inversely transformed in the inverse transform module 230, and as a result, a restored residual block may be generated.

In the intra mode, the intra prediction module 240 performs a spatial prediction by using a pixel value of a pre-encoded block around a current block to generate the prediction block. In the inter mode, the motion correction module 250 corrects the motion by using the motion vector and the reference video stored in the reference video buffer 270 to generate the prediction block.

The restored residual block and the prediction block are added by the adder 255, and the added blocks pass through the filter module 260. The filter module 260 may apply at least one of a deblocking filter, an SAO, and an ALF to the restore block or the restore picture. The filter module 260 outputs the reconfigured video, that is, the restore video. The restore video may be stored in the reference video buffer 270 and used for the inter-screen prediction.

Among the entropy encoding module 210, the inverse quantization module 220, the inverse transform module 230, the intra prediction module 240, the motion correction module 250, the filter module 260, and the reference video buffer 270 included in the video decoding apparatus 200, constituent elements directly related to the video decoding, for example, the entropy encoding module 210, the inverse quantization module 220, the inverse transform module 230, the intra prediction module 240, the motion correction module 250, the filter module 260, and the like are separated from other constituent elements to be expressed as a decoding unit.

Further, the video decoding apparatus 200 may further include a parsing unit (not illustrated) parsing information regarding the encoded video included in the bit stream. The parsing unit may include the entropy decoding module 210, and may also be included in the entropy decoding module 210. The parsing unit may also be implemented as one constituent element of the decoding unit.

A demand for video contents having high resolution of HD or more and high quality has been rapidly increased in various video application fields in recent years, but there is a limit in providing a user's desired level of video service by using the existing video encoding standard including an advanced video coding (AVC) standard. In order to solve such a technical problem, an ISO/IEC MPEG and an ITU-T VCEG which are both standardization groups related to video encoding agreed to configure a joint collaborative team called Joint Collaborative Team on Video Coding (JCT-VC) to develop a next-generation video coding standard and publicized a high efficiency video coding (HEVC) standard call for proposal in order to improve twice encoding efficiency higher than a H.264/AVC standard in Kyoto Conference in January, 2010. In response thereto, 20 video encoding codecs which were developed globally were compared and evaluated in Dresden Conference in April, 2010 and 7 codec technologies which are excellent in terms of encoding efficiency and complexity were combined to decide Test Model under Consideration (TMuC).

Working Draft (WD) 1 which will be a base of an HEVC standard was decided in Guangzhou in October, 2010 and thereafter, the HEVC standard primarily including a tool which is more excellent in encoding performance than complexity, a tool that more significantly decreases than the encoding performance, a tool that improves a parallel processing capability, and a new function supported by a high-level syntax are enhanced in succession through a core experiment (CE) and evaluation of individual tools. Therefore, Committee Draft (CD) and Draft International Standard (DIS) were published in February and July, 2012, respectively and Final Draft International Standard (FDIS) was published early in 2013.

The HEVC standard basically has a video coding structure similar as the existing video compression standards and includes a quad-tree structure that supports a maximum 64×64 encoding unit and a maximum 32×32 transform unit which are encoding tools distinguished from the existing video compression standards, 35 intra-screen prediction modes, a merge mode, entropy encoding that improves a throughput, a simplified deblocking filter, a sample adaptive offset (SAO) which is a new type loop filter, a transform skip mode, and the like.

Herein, the transform skip mode to be handled in the present invention as a method that performs only quantization in a spatial area instead of skipping transformation for the residual blocks is a method that may achieve subjective image quality improve as well as objective image quality improvement in a video in which distortion may occur when a screen contents video (screen contents sequence) is transformed and quantized.

At present, since in the HEVC standard, processing may be performed in the case where the transform skip mode is used and the case where the transform skip mode is not used by parsing a transform skip flag by the unit of 4×4 residual blocks, best encoding performance may be obtained only by encoding the corresponding residual blocks in an optimal case of two cases, thereby increasing the complexity of the encoder. Accordingly, in the present invention, a method is proposed, which decides the transform skip mode used in the residual blocks in the screen in order to reduce the complexity in the HEVC encoder.

Hereinafter, one example of a method for deciding the transform skip mode and the high-speed transform skip mode of the HEVC will be described and a high-speed intra-screen transform skip mode in the method for deciding the high-speed intra-screen transform skip mode will be described. Thereafter, an experimental result of the method proposed in the present invention will be described.

The screen contents video indicates a video rendered and generated from electronic apparatuses including a computer and is frequently used application fields including desktop sharing, a video conference, a remote education, and the like.

Further, the screen contents video has a video feature which is not smooth unlike a natural video. In particular, there are a lot of cases in which the screen contents video has a sharp boundary and high brightness contrast and due to such a feature, even a small distortion phenomenon may exert a bad influence on the image quality of the video. A method is first introduced, which applies the transform skip mode that performs only quantization without transforming the residual blocks generated after the intra-screen prediction to a joint model (JM) which is reference software of an AVC in order to efficiently encode the screen contents video, and an experimental result in which the same method is applied to TMuC and an experimental result applied to an HEVC test model (MH) which is reference software of the HEVC standard are reported.

Meanwhile, the transform skip mode for 4×4 intra-screen residual blocks is adopted in the HEVC standard and thereafter, the transform skip mode may be used even in 4×4 inter-screen residual blocks.

In the HEVC, whether the transform skip mode is used may be decided by the unit of a picture according to a flag parsed in a picture parameter set (PPS). In the case where a value of a flag for the transform skip mode (transform_skip_enable_flag) is 1 and lossless coding by the unit of the encoding unit is not used (that is, a case in which cu_transquant_bypass_flag is not 1), but in the case of 4×4 residual blocks, a transform skip flag (transform_skip_flag) by the unit of the residual blocks may be received for each color component.

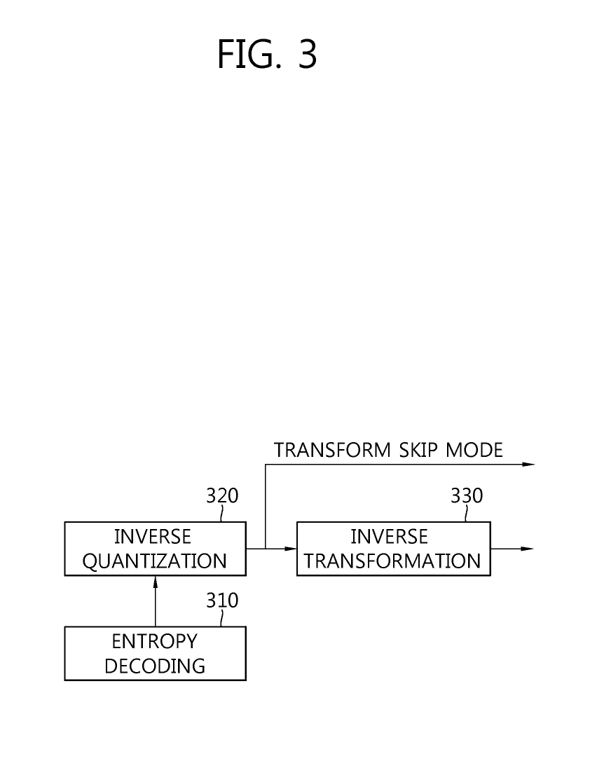

FIG. 3 is a partial conceptual diagram of a decoding apparatus adopting a transform skip mode according to the present invention.

As illustrated, the decoding apparatus includes an entropy decoding module 310, an inverse quantization module 320, and an inverse transform module 330.

The entropy decoding module 310 entropy-decodes the input bit stream according to probability distribution to generate symbols including a symbol having a quantized coefficient form. The entropy decoding method is a method of receiving binary strings to generate respective symbols. The entropy decoding method is similar to the aforementioned entropy encoding method.

The quantized coefficient is inversely quantized in the inverse quantization module 320 and inversely transformed in the inverse transform module 330, and as a result, a restored residual block may be generated.

As illustrated in FIG. 3, when the transform skip mode by the unit of the residual blocks is used, only a simple scaling process is performed in order to adjust a magnitude of a signal in the inversely transformed residual block without inverse transformation after inverse quantization to restore the residual block.

That is, as described above, in the case where the value of the flag for the transform skip mode (transform_skip_enable_flag) is 1 and the lossless coding by the unit of the encoding unit is not used (that is, a case in which cu_transquant_bypass_flag is not 1), but in the case of 4×4 residual blocks, the decoding apparatus may receive the transform skip flag (transform_skip_flag) by the unit of the residual blocks and the video is restored by applying the transform skip mode without passing through the inverse transform module 330 in response thereto.

The HEVC encoder calculates rate-distortion cost in both the case in which the transform skip mode is used and the case in which the transform skip mode is not used and thereafter, decodes the video in an optimal case of both cases. That is, since the encoder may best encoding performance only by calculating the rate-distortion cost in both cases at all times in order to decide the transform skip mode, complexity by the calculation may be increased.

When the case in which the transform skip mode is not used and the case in which the transform skip mode is used are actually compared with each other, in the case where the transform skip mode is used, an intra-screen main experimental condition is used among common experimental conditions and an experiment is performed for four class F videos which are screen content videos, and as a result, a bit rate is decreased by approximately 8% and a total encoding time is increased by approximately 30% with respect to each luminance and chrominance component.

The intra-screen high-speed transform skip mode deciding method is proposed even in the related art in order to reduce the complexity of the encoding apparatus. The intra-screen high-speed transform skip mode deciding method in the related art may be implemented with respect to each of the luminance and chrominance component.

4×4 blocks may be present due to a quad tree structure in the residual blocks adopting the intra-screen prediction and in the case where the intra-screen high-speed transform skip mode is decided with respect to the luminance component, the rate-distortion cost for the transform skip mode is calculated only when prediction block division partitions of the intra-screen encoding unit are N×N to decide whether the transform skip mode is applied.

Meanwhile, only when 8×8 luminance residual blocks corresponding to 4×4 chrominance residual blocks are divided into N×N in deciding the intra-screen transform skip mode for the chrominance component and even one block among divided 4×4 luminance residual blocks corresponding to the 4×4 chrominance residual blocks uses the transform skip mode, the rate-distortion cost for the transform skip mode is calculated.

Hereinafter, the high-speed intra-screen transform skip mode deciding method according to the present invention different from the related art will be described in detail.

As described above, since a change amount of pixels in the video in the case of the screen contents video is not smaller than that in the natural video, that is, since the change amount of the pixels is large, a deviation in magnitude of the signals in the residual blocks of the screen contents video may be larger than that in the residual blocks of the natural video.

Due to such a signal feature, even though transformation used to compress energy of the residual blocks is used, the energy of the residual blocks is not normally compressed. Accordingly, it is difficult to efficiently encode the screen contents video by the existing transformation and quantization.

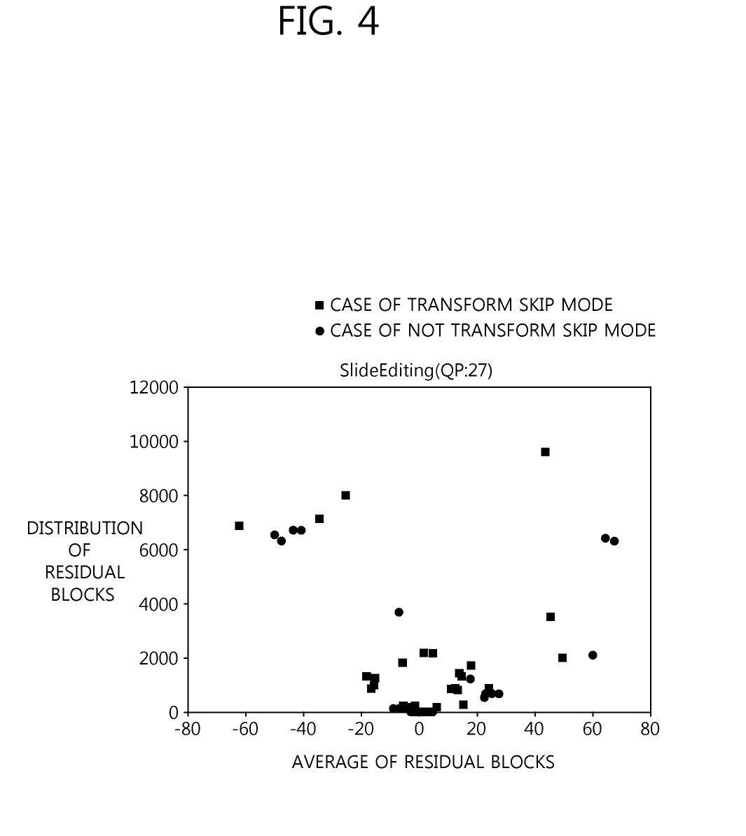

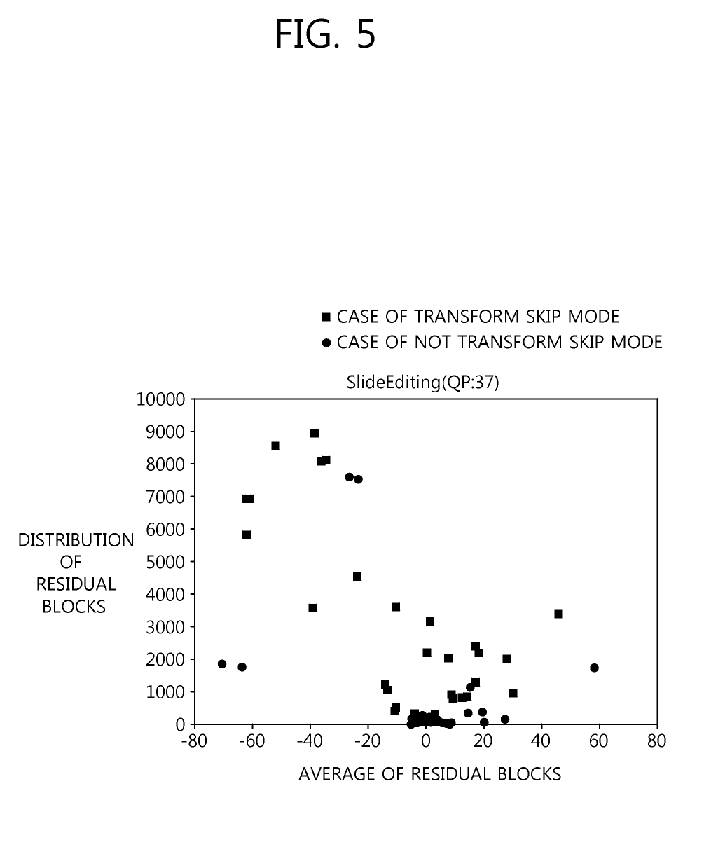

FIG. 4 is a diagram illustrating an average and a distribution of residual blocks in the case where the transform skip mode is applied to a predetermined screen contents video (SlideEditing) and in the case where the transform skip mode is not applied. FIG. 5 is a diagram illustrating an average and a distribution of residual blocks in the case where the transform skip mode is applied to another screen contents video and in the case where the transform skip mode is not applied.

In FIG. 4, QP for the predetermined screen contents video is 27 and in FIG. 5, QP for the screen contents video is 37. Since QP in FIG. 5 has the higher value, there is a higher probability that a signal for the residual will be generated in the video for FIG. 5 than that for FIG. 4.

It can be seen that an average value and a distribution value of residual blocks applied with the transform skip mode through a rate-distortion optimization process is relatively larger than that in the case where the transform skip mode is not used. That is, it can be seen that there are a lot of cases in which the video is encoded in the transform skip mode in the case where the average value and the distribution value are large.

Meanwhile, in the case where the transform skip mode is used and in the case where the transform skip mode is not used, the signal for the residual block may not present. In this case, the residual blocks may be blocks for the prediction block generated by applying the same intra-screen prediction mode. In the case where the signal for the residual blocks is not present, the rate-distortion costs in the case where the transform skip mode is used and in the case where the transform skip mode is not used may be the same as each other.

Further, even though a bit rate for the transform skip flag for signaling whether the transform skip mode is applied is considered, the rate-distortion costs in the case where the transform skip mode is used and in the case where the transform skip mode is not used may not significantly be different from each other.

In this case, whether the signal for the residual blocks is present may be signaled by using a syntax element coded block flag.

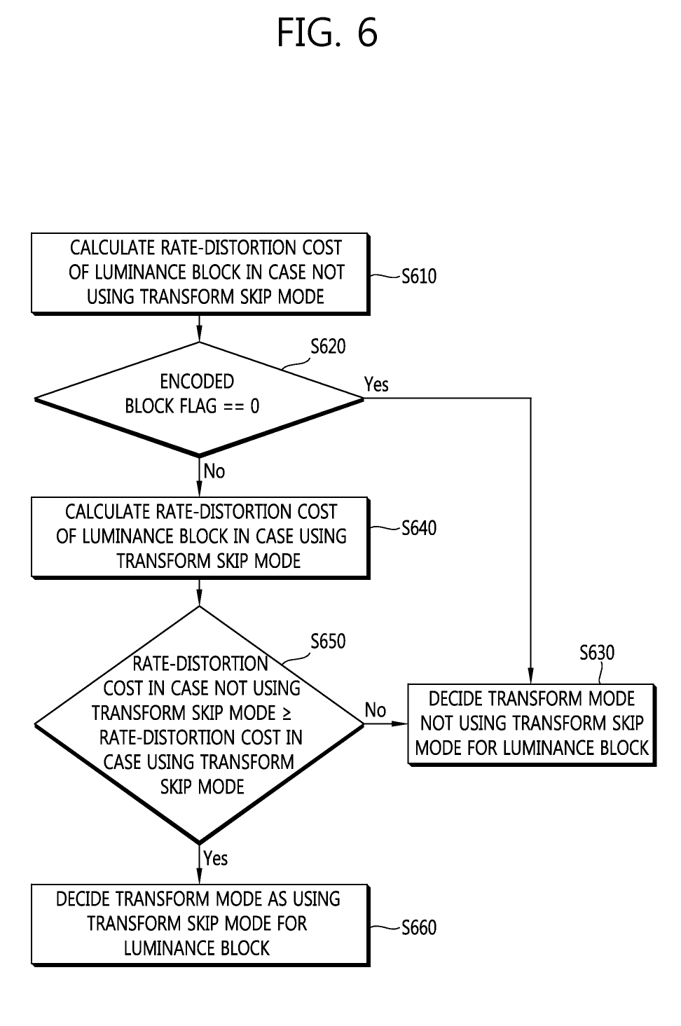

FIG. 6 is a control flowchart for describing a method for deciding a luminance transform skip mode in a high-speed screen according to the present invention.

As illustrated, first, the encoder calculates rate-distortion cost without using a transform skip mode with respect to a luminance block generated by applying an intra-screen prediction mode (S610).

A process of calculating the rate-distortion cost according to a specific mode includes encoding a residual signal according to the corresponding mode. That is, the residual signal is subjected to transformation and quantization to be encoded through the process of calculating the rate-distortion cost without using the transform skip mode.

Thereafter, the encoder judges whether an encoded block flag value indicating whether the residual signal for the luminance block is present is 0 (S620).

Whether the residual signal for the residual block of the luminance block is present may be derived through the process of calculating the rate-distortion cost or by using predetermined flag information. The encoded block flag value is encoded to be signaled to a decoding apparatus.

According to a result of the judgment, when the encoded block flag value for the luminance block is 0, there is a high probability that the encoded block flag value will be 0 even by applying the existing transform skip mode.

Accordingly, when the encoded block flag value for the residual signal is 0, the encoder decides a transform mode not to use the transform skip mode for the luminance block (S630). That is, the encoder may signal to the decoder the encoded residual signal without using the transform skip mode instead of not calculating the rate-distortion cost by using the transform skip mode.

Deciding the transform mode represents whether the transform skip mode is to be applied. That is, deciding the transform mode represents that the encoder judges whether to encode the residual signal by applying the transform skip mode or whether to encode the residual signal without applying the transform skip mode.

When a deviation in magnitude of a signal in the residual block is small, transformation and quantization are performed without using the transform skip mode and thereafter, when the signal is not present in the residual block, there is a high possibility that the signal will not be present in the residual block even by using the transform skip mode. In this case, the rate-distortion costs in the case where the transform skip mode is used and in the case where the transform skip mode is not used may be similar to each other. Therefore, the residual block is encoded through transformation and quantization without using the transform skip mode to correspond to the encoded block flag as described in S630.

According to the embodiment, since the rate-distortion cost for the transform skip mode is not calculated when the condition is met, the transform mode may be decided more rapidly than the existing transform skip mode deciding method. That is, the complexity of the encoder may be reduced and rapid encoding may be achieved through the method for deciding the luminance transform skip mode in the high-speed screen according to the embodiment.

On the contrary, according to the judgment result, when the encoded block flag value for the luminance block is not 0, the encoder calculates the rate-distortion cost for the luminance block in the case where the transform skip mode is used (S640).

Thereafter, the encoder compares the rate-distortion cost for the luminance block calculated in step S610 and the rate-distortion cost calculated in step S640 to decide a mode in the case where the cost is the smaller as an optimal mode.

That is, when the rate-distortion cost in the case where the transform skip mode is not used is equal to or larger than the rate-distortion cost in the case where the transform skip mode is used (S650), the encoder decides the mode having the smaller rate-distortion cost for the luminance block, that is, the transform skip mode as the transform mode (S660).

When the rate-distortion cost in the case where the transform skip mode is not used is equal to or not larger than the rate-distortion cost in the case where the transform skip mode is used (S650), the encoder decides that the transform skip mode is not used for the luminance block (S630).

In summary, the rate-distortion cost in the case where the transform skip mode is used and the rate-distortion cost in the case where the transform skip mode is not used are sequentially calculated and thereafter, a case having a minimum rate-distortion cost is decided as the optimal mode in the related art, but in the high-speed transform skip mode deciding method according to the embodiment, when the encoded block flag value is 0 after the rate-distortion cost in the case where the transform skip mode is not used is calculated, the transform mode may be decided as not applying the transform skip mode without calculating the rate-distortion cost in the case where the transform skip mode is applied to the corresponding luminance block. According to the embodiment, calculating the rate-distortion cost in any one case is skipped by analyzing a feature of the residual block to reduce the complexity of the encoder.

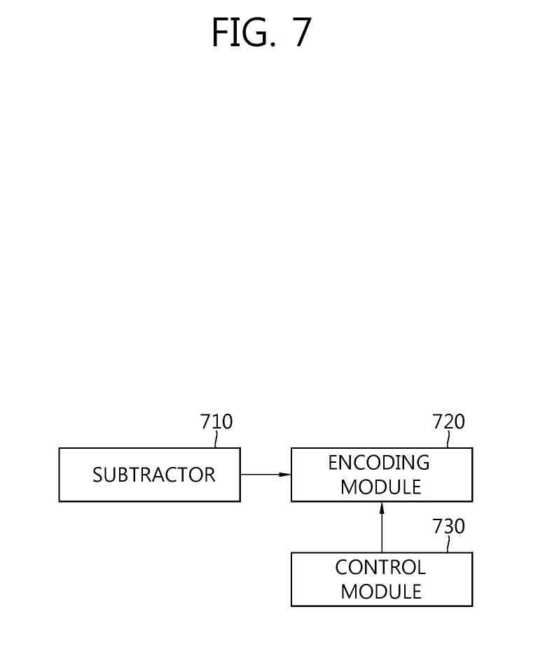

FIG. 7 is a control block diagram of an encoder according to an embodiment of the present invention.

As illustrated, the encoder includes a subtractor 710, an encoding module 720, and a control module 730.

The subtractor 710 generates a residual block corresponding to a difference between a target block of an original video and a prediction block for the target block. In this case, an intra-screen prediction is applied to the prediction block.

The encoding module 720 transforms, quantizes, and encodes the residual block to calculate a first rate-distortion cost.

The control module 730 judges whether the encoded block flag indicating whether the residual signal of the residual block is present is 0 and according to a result of the judgment, when the encoded block flag is 0, the transform mode is decided as not applying the transform skip mode to the residual block.

The control module 730 performs quantization and encoding without transforming the residual block to control the encoding module 720 to calculate a second rate-distortion cost by performing quantization and encoding without transforming the residual block when the encoded block flag is not 0 according to a result of the judgment.

The control module 730 compares the first rate-distortion cost and the second rate-distortion cost and decides the transform mode as not applying the transform skip mode to the residual block when the first rate-distortion cost is equal to or larger than the second rate-distortion cost according to a result of the comparison and decides the transform mode as applying the transform skip mode to the residual block when the first rate-distortion cost is smaller than the second rate-distortion cost.

In this case, the residual block may be a luminance block including a luminance component and a chrominance block including a chrominance block.

The encoding module 720 and the control module 730 are separately illustrated in terms of functions thereof and the components are merged to be implemented as one chip or module. Therefore, the scope of the present invention is not limited to the figure of FIG. 7.

According to another embodiment of the present invention, the method for deciding the transform skip mode in the high-speed screen may be applied to the chrominance block constituted by the chrominance component as well as the luminance block.

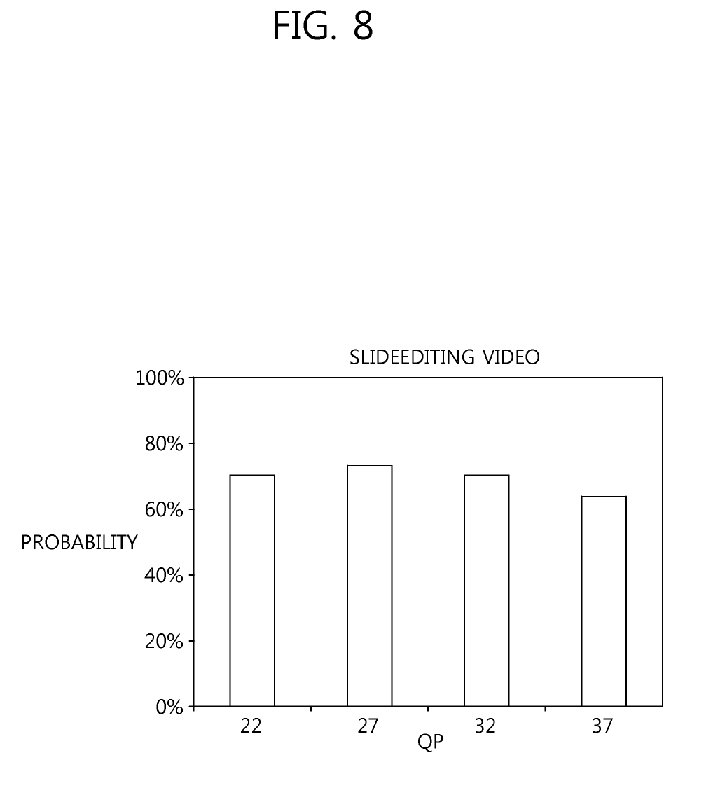

FIG. 8 is a graph illustrating a probability that an encoded block flag of a luminance block is 1 in the case where an encoded block flag of a chrominance block is 1.

FIG. 8 illustrates a probability that an encoded block flag of a luminance residual block will be 1 when the encoded block flag for one residual block of a chrominance U residual block and a chrominance V residual block is 1 with respect to a predetermined video (SlideEditing video).

As illustrated, when the encoded block flag of the chrominance residual block is 1 regardless of the QP value, it is illustrated that the encoded block flag of the luminance residual block is 1 in the case of 60% or more.

It can be seen that a correlation between the encoded block flag of the luminance residual block and the encoded block flag of the chrominance residual block is significantly high through FIG. 8. Therefore, it may be decided whether the rate-distortion cost for the transform skip mode of the chrominance block is calculated according to the encoded block flag of the luminance block by using the correlation.

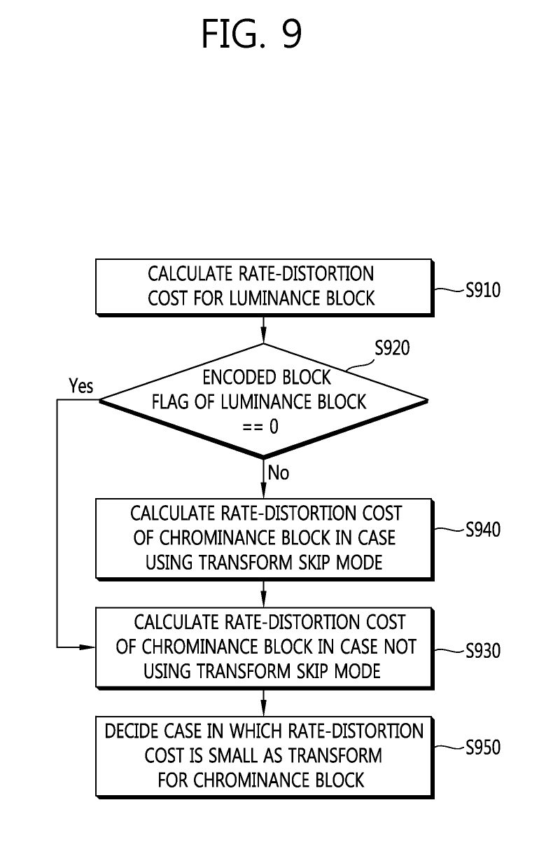

FIG. 9 is a control flowchart for describing a method for determining a chrominance transform skip mode in a high-speed screen according to an embodiment of the present invention.

Referring to FIG. 9, first, a rate-distortion cost for a luminance block is calculated (S910).

That is, in this case, a rate-distortion cost is calculated when transformation and quantization are performed without applying a transform skip mode to the luminance block.

Thereafter, the encoder judges whether an encoded block flag value indicating whether the residual signal for the luminance block is present is 0 (S920).

When the encoded block flag for the luminance block is 0, a probability that the encoded block flag for the chrominance block will be 0 is high, and as a result, the encoder calculates a rate-distortion cost of the chrominance block in the case where the transform skip mode is not used (S930). The residual block is encoded through transformation and quantization without applying the transform skip mode to the chrominance block by calculating the rate-distortion cost of the chrominance block without using the transform skip mode.

On the contrary, when the encoded block flag value for the luminance block is not 0, the encoder calculates the rate-distortion cost for the chrominance block in the case where the transform skip mode is used (S940).

In addition, the rate-distortion cost of the chrominance block in the case where the transform skip mode is not used is calculated like the existing transform skip mode deciding method (S930).

When calculating the rate-distortion costs in the case where the transform skip mode for the chrominance block is used and the transform skip mode is not used is completed, the encoder decides the transform mode for the chrominance block in the case where the rate-distortion cost is the smaller (S950).

According to the embodiment, calculating the rate-distortion cost for the transform skip mode of the chrominance block is skipped to reduce the complexity of the encoder.

When the embodiment is applied to deciding the transform skip mode, the proposed method for deciding the chrominance transform skip mode in the high-speed screen may be applied only in the case where the sum of encoded block flags of the respective residual blocks divided when 8×8 luminance residual blocks corresponding to the 4×4 chrominance residual blocks are divided.

In another embodiment of the present invention, the transform mode may be decided through the process of FIG. 6 even with respect to the chrominance block regardless of the encoded block flag for the luminance block.

A result of implementing the method for deciding the transform skip mode in the high-speed screen proposed in the present invention in predetermined software (HM 9.0) will be described below. In this case, the intra-screen main experimental condition was used among the common experimental conditions used in HEVC standardization and four class F videos which are the screen contents videos were used as experiment videos and a decrease and an increase of a bit rate were calculated by using a bitrate distortion rate (BD-rate).

Table 1 illustrates individual performances for luminance and chrominance blocks in deciding the transform skip mode in the high-speed screen according to the present invention.

TABLE 1

| | | Proposed high-speed | | | | Proposed high-speed | | | | Proposed high-speed intra- | | | |
|---|---|---|---|---|---|---|---|---|---|---|---|---|---|
| | | intra-screen luminance | | | | intra-screen chrominance | | | | screen transform skip mode | | | |
| | | transform skip mode deciding | | | | transform skip mode deciding | | | | (luminance + chrominance) | | | |
| | | | | | Total | | | | Total | | | | Total |
| | | | | | encoding | | | | encoding | | | | encoding |
| | Q | BD-RATE (%) | | | time de- | BD-RATE (%) | | | time de- | BD-RATE (%) | | | time de- |
| Video | P | Y | U | V | creased (%) | Y | U | V | creased (%) | Y | U | V | creased (%) |
| Basket- | 22 | 0.04 | −0.14 | −0.13 | 1.02 | −0.01 | 0.15 | 0.19 | 3.52 | 0.05 | −0.03 | 0.03 | 4.57 |
| ballDrillText | 27 | | | | 2.90 | | | | 4.57 | | | | 7.77 |
| (832 × 480 | 32 | | | | 4.72 | | | | 5.55 | | | | 10.17 |
| @ 50 fps) | 37 | | | | 6.04 | | | | 6.61 | | | | 12.69 |
| ChinaSpeed | 22 | 0.21 | −0.29 | −0.25 | 2.91 | 0.00 | 0.09 | 0.24 | 4.34 | 0.20 | −0.20 | −0.05 | 7.35 |
| (1024 × 768 | 27 | | | | 3.89 | | | | 5.05 | | | | 8.55 |
| @ 30 fps) | 32 | | | | 5.09 | | | | 6.01 | | | | 10.67 |
| | 37 | | | | 6.05 | | | | 5.54 | | | | 12.18 |
| SlideEditing | 22 | 0.13 | −0.01 | −0.14 | 2.42 | −0.01 | 0.12 | 0.05 | 5.44 | 0.10 | 0.10 | −0.08 | 8.23 |
| (1280 × 720 | 27 | | | | 2.87 | | | | 4.68 | | | | 8.20 |
| @ 30 fps) | 32 | | | | 4.43 | | | | 4.58 | | | | 8.10 |
| | 37 | | | | 4.49 | | | | 5.16 | | | | 9.60 |
| SlideShow | 22 | 0.22 | −0.26 | −0.39 | 6.54 | −0.03 | −0.01 | 0.03 | 6.30 | 0.21 | −0.27 | −0.27 | 12.54 |
| (1280 × 720 | 27 | | | | 7.56 | | | | 5.89 | | | | 13.47 |
| @ 20 fps) | 32 | | | | 7.83 | | | | 6.53 | | | | 14.34 |
| | 37 | | | | 8.11 | | | | 8.06 | | | | 15.05 |

| | | | | | | | | | | | | |
|---|---|---|---|---|---|---|---|---|---|---|---|---|
| Average | 0.15 | −0.18 | −0.23 | 4.81 | −0.01 | 0.09 | 0.13 | 5.49 | 0.14 | −0.10 | −0.09 | 10.22 |

First, the transform skip mode in the HM 9.0 as illustrated in Table 1, but individual performance integrated performances of deciding the luminance transform skip mode in the high-speed screen and deciding the chrominance transform skip mode in the high-speed screen proposed based on a method which is not used were measured in the high-speed transform skip mode deciding method.

As seen through Table 1, the method for deciding the luminance transform skip mode in the high-speed screen reduces a total encoding time by approximately 5%. According to the method for deciding the luminance transform skip mode in the high-speed screen, the bit rate for the luminance component was increased by approximately 0.15% and the bit rate for the chrominance component was decreased by approximately 0.2%.

When the method for deciding the chrominance transform skip mode in the high-speed screen is applied, the total encoding time was decreased by approximately 5.5% and there no difference in performance of the luminance component, but the bit rate for the chrominance component was increased by approximately 0.1%.

Last, when both methods are integratedly applied, the total encoding time was decreased by approximately 10%, the bit rate for the luminance component was increased by approximately 0.14%, and the bit rate for the chrominance component was decreased by approximately 0.1%.

In particular, a BasketballDrillText video is acquired by synthesizing the screen contents video with the natural video and a method proposed even in a vide having a lot of features of the natural video may shorten an encoding time without degradation of performance.

Table 2 illustrates comparison and integration performances of the method for deciding the transform skip mode in the high-speed screen.

TABLE 2

| | | | | | | | | | | Existing high-speed mode deciding + | | | |
|---|---|---|---|---|---|---|---|---|---|---|---|---|---|
| | | | | | | Proposed high-speed mode deciding | | | | Proposed high-speed mode deciding | | | |
| | | Existing high-speed mode deciding | | | | (luminance + chrominance) | | | | (luminance + chrominance) | | | |
| | | | | | Total | | | | Total | | | | Total |
| | | | | | encoding | | | | encoding | | | | encoding |
| | Q | BD-RATE (%) | | | time de- | BD-RATE (%) | | | time de- | BD-RATE (%) | | | time de- |
| Video | P | Y | U | V | creased (%) | Y | U | V | creased (%) | Y | U | V | creased (%) |
| Basket- | 22 | −0.73 | −1.32 | −1.29 | −18.47 | −0.69 | −2.30 | −2.35 | −27.79 | −0.70 | −1.39 | −1.38 | −16.19 |
| ballDrillText | 27 | | | | −17.04 | | | | −21.07 | | | | −12.83 |
| (832 × 480 | 32 | | | | −15.71 | | | | −16.56 | | | | −10.31 |
| @ 50 fps) | 37 | | | | −15.48 | | | | −13.10 | | | | −8.94 |
| ChinaSpeed | 22 | −10.74 | −10.16 | −12.23 | −17.39 | −10.83 | −11.13 | −13.29 | −21.38 | −10.58 | −10.39 | −12.42 | −14.24 |
| (1024 × 768 | 27 | | | | −16.46 | | | | −18.86 | | | | −12.53 |
| @ 30 fps) | 32 | | | | −16.73 | | | | −15.60 | | | | −10.87 |
| | 37 | | | | −15.87 | | | | −13.29 | | | | −9.14 |
| SlideEditing | 22 | −14.59 | −14.18 | −13.80 | −17.44 | −14.71 | −14.50 | −14.23 | −21.12 | −14.48 | −14.17 | −13.89 | −14.88 |
| (1280 × 720 | 27 | | | | −17.68 | | | | −18.96 | | | | −14.01 |
| @ 30 fps) | 32 | | | | −19.01 | | | | −19.74 | | | | −14.06 |
| | 37 | | | | −17.47 | | | | −17.02 | | | | −13.52 |
| SlideShow | 22 | −4.28 | −2.98 | −2.57 | −17.73 | −4.24 | −3.62 | −3.18 | −14.66 | −4.04 | −3.25 | −2.64 | −10.16 |
| (1280 × 720 | 27 | | | | −16.82 | | | | −12.47 | | | | −8.98 |
| @ 20 fps) | 32 | | | | −17.41 | | | | −11.44 | | | | −8.69 |
| | 37 | | | | −16.37 | | | | −10.35 | | | | −6.93 |

| | | | | | | | | | | | | |
|---|---|---|---|---|---|---|---|---|---|---|---|---|
| Average | −7.58 | −7.16 | −7.47 | −17.07 | −7.62 | −7.89 | −8.26 | −17.09 | −7.45 | −7.30 | −7.58 | −11.64 |

Table 2 illustrates a comparison experiment result for integration performance of the existing high-speed transform skip mode deciding method, the method for deciding the transform skip mode in the high-speed screen proposed in the present invention, and the method for deciding based on a method not using both the existing transform skip mode and high-speed transform skip mode deciding methods.

In the existing high-speed transform skip mode deciding method, the bit rate is decreased by 7.58%, 7.16%, and 7.47% and the total encoding time is increased by approximately 17% for each luminance and chrominance component.

When the proposed method for deciding the chrominance transform skip mode in the high-speed screen is applied, the bit rate is decreased by 7.62%, 7.89%, and 8.26% and the total encoding time is increased by approximately 17% for each luminance and chrominance component.

When both the existing high-speed transform skip mode deciding method and the proposed method are used, the bit rate is decreased by 7.45%, 7.30%, and 7.58% and the total encoding time is increased by approximately 17% for each luminance and chrominance component.

That is, in the proposed method for deciding the transform skip mode in the high-speed screen, the total encoding time is decreased at a similar level as in the existing high-speed transform skip mode deciding method, but the proposed method for deciding the transform skip mode in the high-speed screen is a little more excellent than the existing high-speed transform skip mode deciding method in terms of encoding performance.

Further, when the transform skip mode is used without using the method for deciding the transform skip mode in the high-speed screen, the total encoding time is increased by approximately 30%, while when both the existing high-speed transform skip mode deciding method and the proposed method are used, the total encoding time is increased by approximately 11.5% with no difference in encoding performance.

That is, when both the existing high-speed transform skip mode deciding method and the proposed method are used based on the case of using the transform skip mode without using the method for deciding the transform skip mode in the high-speed screen, the total encoding time may be decreased by approximately 62%.

The present invention proposes the high-speed transform skip mode deciding method for the luminance and chrominance components in the screen in order to reduce the complexity of the HEVC encoder and when the proposed method is compared with the existing transform mode deciding method, the BD-Rate for the luminance component is increased by 0.14%, but the total encoding time may be decreased by approximately 10.22%.

In the aforementioned embodiments, methods have been described based on flowcharts as a series of steps or blocks, but the methods are not limited to the order of the steps of the present invention and any step may occur in a step or an order different from or simultaneously as the aforementioned step or order. Further, it can be appreciated by those skilled in the art that steps shown in the flowcharts are not exclusive and other steps may be included or one or more steps do not influence the scope of the present invention and may be deleted.

The aforementioned embodiments include examples of various aspects. All available combinations for expressing various aspects cannot be described, but it can be recognized by those skilled in the art that other combinations can be used. Therefore, all other substitutions, modifications, and changes of the present invention that belong to the appended claims can be made.

What is claimed is:

1. A video encoding method, comprising:
generating a residual block corresponding to a difference between a target block of an original video and a prediction block for the target block;
calculating a first rate-distortion cost by transforming, quantizing, and encoding the residual block;
judging whether an encoded block flag indicating whether a residual signal of the residual block is present is 0; and
deciding a transform mode as not applying a transform skip mode to the residual block when the encoded block flag is 0 according to a result of the judgment.

2. The method of claim 1, further comprising:
calculating a second rate-distortion cost by quantizing and encoding the residual block without transformation when the encoded block flag is not 0 according to the judgment result.

3. The method of claim 2, further comprising:
comparing the first rate-distortion cost and the second rate-distortion cost with each other;
deciding the transform mode as applying the transform skip mode to the residual block when the first rate-distortion cost is equal to or larger than the second rate-distortion cost according to a result of the comparison; and
deciding the transform mode as not applying the transform skip mode to the residual block when the first rate-distortion cost is smaller than the second rate-distortion cost according to a result of the comparison.

4. The method of claim 1, wherein an intra-screen prediction is applied to the prediction block.

5. The method of claim 1, wherein the residual block is a luminance block including a luminance component.

6. The method of claim 1, wherein the residual block is a chrominance block including a chrominance component.

7. A video encoding method, comprising:
generating a first residual block corresponding to a difference between the target block of the original video and a luminance block constituted by luminance components for the target block and a second residual block corresponding to a difference between the target block and a chrominance prediction block constituted by chrominance components for the target block;
calculating the first rate-distortion cost by transforming, quantizing, and encoding the first residual block;
judging whether an encoded block flag indicating whether a residual signal of the first residual block is present is 0; and
deciding the transform mode as not applying a transform skip mode to the second residual block and transforming, quantizing, and encoding the second residual block when the encoded block flag is 0 according to a result of the judgment.

8. The method of claim 7, wherein:
when the encoded block flag is not 0 according to the judgment result,
calculating a second rate-distortion cost by transforming, quantizing, and encoding the second residual block;
calculating a third rate-distortion cost without transforming, quantizing, and encoding the second residual block;
comparing the second rate-distortion cost and the third rate-distortion cost with each other;
deciding the transform mode as applying the transform skip mode to the second residual block when the second rate-distortion cost is equal to or larger than the third rate-distortion cost according to a result of the comparison; and
deciding the transform mode as not applying the transform skip mode to the second residual block when the second rate-distortion cost is smaller than the third rate-distortion cost according to a result of the comparison.

9. The method of claim 7, wherein:
the size of the second residual block is 4×4,
the first residual block having a size of 8×8 corresponding to the second residual block is divided, and
the sum of encoded block flags for the first residual blocks which are divided is equal to or more than 1.

10. A video encoding apparatus, comprising:
a subtractor generating a residual block corresponding to a difference between a target block of an original video and a prediction block for the target block;
an encoding module calculating a first rate-distortion cost by transforming, quantizing, and encoding the residual block;
a control module judging whether an encoded block flag indicating whether a residual signal of the residual block is present is 0 and according to a result of the judgment, when the encoded block flag is 0, deciding the transform mode as not applying the transform skip mode to the residual block.

11. The apparatus of claim 10, wherein the control module controls the encoding module top calculate a second rate-distortion cost by quantizing and encoding the residual block without transformation when the encoded block flag is not 0 according to the judgment result.

12. The apparatus of claim 11, wherein The control module compares the first rate-distortion cost and the second rate-distortion cost and decides the transform mode as applying the transform skip mode to the residual block when the first rate-distortion cost is equal to or larger than the second rate-distortion cost according to a result of the comparison and decides the transform mode as not applying the transform skip mode to the residual block when the first rate-distortion cost is smaller than the second rate-distortion cost.

13. The apparatus of claim 10, wherein an intra-screen prediction is applied to the prediction block.

14. The apparatus of claim 10, wherein the residual block is a luminance block including a luminance component.

15. The apparatus of claim 10, wherein the residual block is a chrominance block including a chrominance component.

16. A video encoding apparatus, comprising:
a subtractor generating a first residual block corresponding to a difference between the target block of the original video and a luminance block constituted by luminance components for the target block and a second residual block corresponding to a difference between the target block and a chrominance prediction block constituted by chrominance components for the target block;
an encoding module calculating the first rate-distortion cost by transforming, quantizing, and encoding the first residual block;
a control module judging whether an encoded block flag indicating whether a residual signal of the first residual block is present is 0 and according to a result of the judgment, when the encoded block flag is 0, deciding the transform mode as not applying the transform skip mode to the second residual block, and
controlling the encoding module to transform, quantize, and encode the second residual block.

17. The apparatus of claim 16, wherein:
when the encoded block flag is not 0 according to the judgment result,
the encoding module calculates a second rate-distortion cost by transforming, quantizing, and encoding the second residual block and calculates a third rate-distortion cost by quantizing and encoding the second residual block without transformation, and
the control module compares the second rate-distortion cost and the third rate-distortion cost and decides the transform mode as applying the transform skip mode to the residual block when the second rate-distortion cost is equal to or larger than the third rate-distortion cost according to a result of the comparison and decides the transform mode as not applying the transform skip mode to the residual block when the second rate-distortion cost is smaller than the third rate-distortion cost.

18. The apparatus of claim 1, wherein:
the size of the second residual block is 4×4,
the first residual block having a size of 8×8 corresponding to the second residual block is divided, and
the sum of encoded block flags for the first residual blocks which are divided is equal to or more than 1.
